(19) United States
(12) Patent Application Publication
(10) Pub. No.: US 2009/0198671 A1
(43) Pub. Date: Aug. 6, 2009

(54) SYSTEM AND METHOD FOR GENERATING SUBPHRASE QUERIES

(75) Inventors: Ruofei Zhang, San Jose, CA (US); Haibin Cheng, Lansing, MI (US); Yefei Peng, San Jose, CA (US); Benjamin Rey, Eguilles (FR); Jianchang Mao, San Jose, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/025,947

(22) Filed: Feb. 5, 2008

(51) Int. Cl. G06F 17/30

(52) U.S. Cl. 707/5; 707/E17.083

(57) ABSTRACT

A system for generating subphrase queries. The system includes a sequence label modeling engine and a regression modeling engine. The sequence label modeling engine generates a plurality of subphrase queries by indexing through each token in a search phrase and labeling each token based on an association to other tokens in the search phrase. The regression modeling engine scores each subphrase query at least partially on the association according to a scoring model. The regression modeling engine identifies the subphrase query with the highest score which may then be used for identifying a sponsored search list or a web search item.

### FIELD OF THE INVENTION

The present invention generally relates to a system for generating subphrase queries.

### DESCRIPTION OF RELATED ART

Generally, search strings are used as the basis of web or advertisement searching. However, it is possible that no entries match all of the words in the search string. In this case, it is generally not acceptable to just return no results. Therefore, it is useful to generate subphrase queries that utilize a subset of the search string and return results that match less than all of the words in the query. While using subphrase queries for web searching is important, they are particularly important in the context of advertisements and sponsored searches.

A sponsored search is a service that finds advertiser listings most relevant to a search request submitted by a partner. It is one of the most mature and profitable business models in Internet industry. When a sponsored search technology provider (hereafter called provider) receives a user submitted query, it transforms the query to its most meaningful and standardized form, and then matches the resulting query to terms that advertisers have bidded on. When these match, the provider delivers corresponding advertiser (sponsored) listings to the partner for rendering in the user's browser. Clearly in the case of a sponsored search, failing to provide relevant results is unacceptable as it is a lost sales opportunity for the provider. However, providing relevant results using less than the full query may be acceptable.

In view of the above, it is apparent that there exists a need for a system and method for generating a subphrase query

### SUMMARY

In satisfying the above need, as well as overcoming the drawbacks and other limitations of the related art, the present invention provides a system and method for generating subphrase queries.

The system includes a sequence label modeling engine and a regression modeling engine. The sequence label modeling engine generates a plurality of subphrase queries by indexing through each token in a search phrase and labeling each token based on an association to other tokens in the search phrase. The sequence label modeling engine provides a ranked list of subphrase queries to the regression modeling engine. The regression modeling engine scores each subphrase query at least partially on the association according to a scoring model. The regression modeling engine ranks the subphrase queries and identifies the subphrase query with the highest score which may then be used for identifying a sponsored search or a web search.

The sequence label modeling engine may utilize a maximum entropy or a conditional random field technique. As such, the sequence label modeling engine may construct the each subphrase query based on the sequential labeling of each token. Each token may be labeled according to the current token, a left bi-gram, a right bi-gram, a two-sided tri-gram, the previous label, or the left label bi-gram.

Conventionally after doing canonization the canonized queries are matched with the bidded terms from advertisers to find the relevant ads. As discussed above, using an exact match strategy does not maximize the monetization opportunities. First, many queries, especially long queries, may not have exact match in the bidded term database thus no ads will be returned, even though there are many relevant ads whose bidded terms match with some subphrases of the original query. Some of those sub-phrases may capture the semantics of the query very well. For example, if the bidded term is “diamond ring” and the query string is “diamond ring setting”. Using an exact match this ad would not be returned but the subphrase match would succeed. Accordingly, using an exact match strategy with long search strings is not monetizable. However, if commercial subphrases can be extracted which capture the major semantics of the query, those subphrases may be used to match bidded terms. As such, the ability to monetize these queries using subphrase queries can be improved substantially. At the same time, a quality metric may be defined and measured automatically for the commercial subphrases so that the ad listings can be ranked to optimize click through rate (CTR) on the search page.

The system described serves to extract all commercial subphrases from a query accurately. In addition, the system develops an automatic ranking methodology to score the (query, subphrase) pairs across different queries based on the clickability of the ads which match the subphrase. To achieve this, a hybrid machine learning based approach was developed. The approach combines natural language processing (NLP) and nonlinear regression together in a synergistic way such that both the commercial subphrase extraction and ranking are conducted in a systematic learning system.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of an exemplary system for generating supplemental information for an advertisement;

FIG. 2 is an image of an exemplary search web page;

FIG. 3 is a schematic view of the interaction between the sequence label modeling engine and the regression modeling engine;

FIG. 4 is a flowchart illustrating a method for training the sequence label modeling engine;

FIG. 5 is a flowchart illustrating a method for training the regression modeling engine; and

FIG. 6 is a flowchart illustrating a method for the run time process of the system.

### DETAILED DESCRIPTION

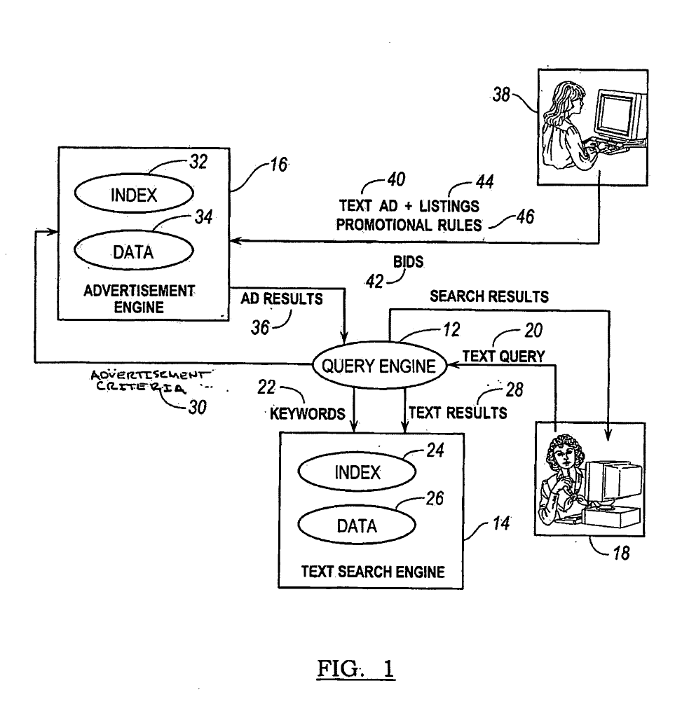

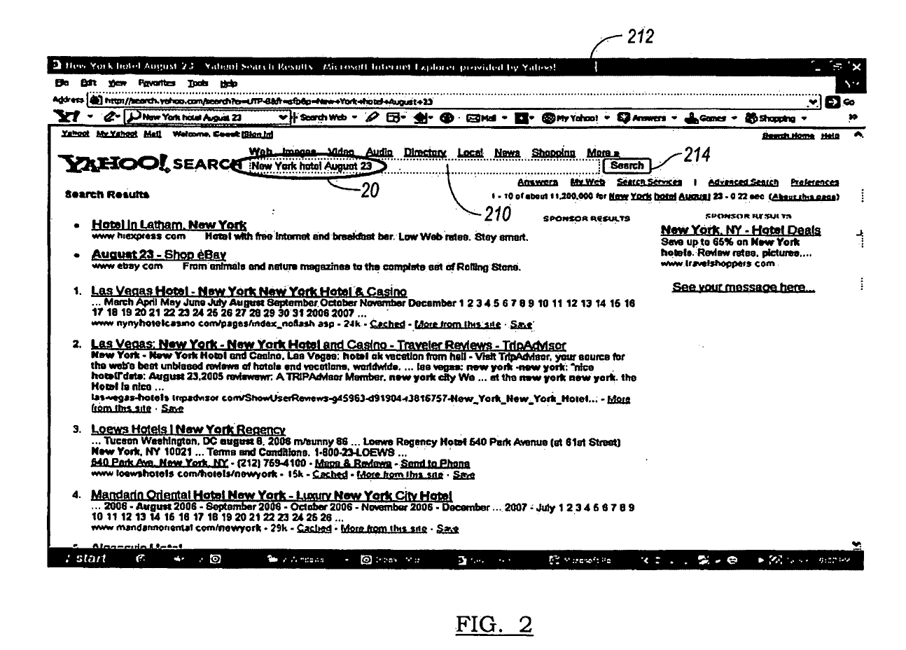

FIG. 1 shows a system 10, according to one embodiment, which includes a query engine 12 and an advertisement engine 16. The query engine 12 is in communication with a user system 18 over a network connection, for example over an Internet connection. In the case of a web search page, the query engine 12 is configured to receive a text query 20 to initiate a web page search. The text query 20 may be a simple text string including one or more keywords that identify the subject matter for which the user wishes to search. For example, the text query 20 may be entered into a text box 210 located at the top of the web page 212, as shown in FIG. 2. In the example shown, five keywords “New York hotel August 23” have been entered into the text box 210 and together form the text query 20. In addition, a search button 214 may be provided. Upon selection of the search button 214, the text query 20 may be sent from the user system 18 to the query engine 12. The text query 20 also referred to as a raw user query, may be simply a list of terms known as keywords.

The query engine 12 provides the text query 20, to the text search engine 14 as denoted by line 22. The text search engine 14 includes an index module 24 and the data module 26. The text search engine 14 compares the keywords 22 to information in the index module 24 to determine the correlation of each index entry relative to the keywords 22 provided from the query engine 12. The text search engine 14 then generates text search results by ordering the index entries into a list from the highest correlating entries to the lowest correlating entries. The text search engine 14 may then access data entries from the data module 26 that correspond to each index entry in the list. Accordingly, the text search engine 14 may generate text search results 28 by merging the corresponding data entries with a list of index entries. The text search results 28 are then provided to the query engine 12 to be formatted and displayed to the user.

The query engine 12 is also in communication with the advertisement engine 16 allowing the query engine 12 to tightly integrate advertisements with the content of the page and, more specifically, the user query and search results in the case of a web search page. To more effectively select appropriate advertisements that match the user's interest and query intent, the query engine 12 is configured to further analyze the text query 20 and generate a more sophisticated set of advertisement criteria 30. The query intent may be better categorized by defining a number of domains that model typical search scenarios. Typical scenarios may include looking for a hotel room, searching for a plane flight, shopping for a product, or similar scenarios. Alternatively, if the web page is not a web search page, the page content may be analyzed to determine the user's interest to generate the advertisement criteria 30.

The advertisement criteria 30 is provided to the advertisement engine 16. The advertisement engine 16 includes an index module 32 and a data module 34. The advertisement engine 16 performs an ad matching algorithm to identify advertisements that match the user's interest and the query intent. The advertisement engine 16 compares the advertisement criteria 30 to information in the index module 32 to determine the correlation of each index entry relative to the advertisement criteria 30 provided from the query engine 12. The scoring of the index entries may be based on an ad matching algorithm that may consider the domain, keywords, and predicates of the advertisement criteria, as well as the bids and listings of the advertisement. The bids are requests from an advertiser to place an advertisement. These requests may typically be related domains, keywords, or a combination of domains and keywords. Each bid may have an associated bid price for each selected domain, keyword, or combination relating to the price the advertiser will pay to have the advertisement displayed. Listings provide additional specific information about the products or services being offered by the advertiser. The listing information may be compared with the predicate information in the advertisement criteria to match the advertisement with the query. An advertiser system 38 allows advertisers to edit ad text 40, bids 42, listings 44, and rules 46. The ad text 40 may include fields that incorporate, domain, general predicate, domain specific predicate, bid, listing or promotional rule information into the ad text.

The advertisement engine 16 may then generate advertisement search results 36 by ordering the index entries into a list from the highest correlating entries to the lowest correlating entries. The advertisement engine 16 may then access data entries from the data module 34 that correspond to each index entry in the list from the index module 32. Accordingly, the advertisement engine 16 may generate advertisement results 36 by merging the corresponding data entries with a list of index entries. The advertisement results 36 are then provided to the query engine 12. The advertisement results 36 may be provided to the user system 18 for display to the user.

Depending on whether the subphrase query is being generated for the web search or advertisement search the subphrase generation may be implemented in the query engine or the advertisement engine. The developed learning system can be decomposed into two components. One component uses a sequence labeling technique based on NLP to learn the important contextual features and generate subphrases. This component formulates the subphrase extraction as a sequence labeling problem. Each token (either word or unit) can be labeled using two labels: KEEP or DROP. After each token is given a label, those tokens labeled with KEEP compose a subphrase. To label the queries, a set of training data in the form of (query, subphrase) may be used. A machine learning algorithm is applied to the training data. The machine learning algorithm uses contextual features such as bi-gram/tri-gram for tokens/labels in a query and learns the optimized label sequence for the query based on a pre-defined loss function. One advantage of this sequence labeling based approach is that it captures the contextual features which directly affect the quality of the extracted subphrases. However, there may also be disadvantages of this approach alone. This approach can only learn the syntactic contexts of queries, but cannot optimize the clickablity of the subphrases, which may also be useful. For example, when the query “affordable tiffany diamond engagement ring” is analyzed, two subphrases are extracted using this approach. The two subphrases are “diamond engagement ring” and “tiffany ring” in the order of labeling probability. Although semantically the first subphrase is more relevant than the second subphrase, it happens that the second subphrase gets more clicks (thus higher clickablity) than the first one. Using only a sequence labeling approach, the not-syntactically related features (i.e., clickability) are not incorporated into the learning algorithm directly and thus the generated subphrases and their scores may not be the optimal ones to maximize the click through rate (CTR).

The scores generated for each subphrase of a query are actually the probability of the label sequence for the query. They are only meaningful to compare different subphrases for the same query. For pairs (query, subphrase) for different queries, the comparability of scores is questionable. For example, the pair (“Toyoto Camry car accident report”, “Toyota Camry”) and (“Toyota Camry car accident report”, “car accident report”) have scores 0.76 and 0.54 respectively for query “Toyota Camry car accident report”. These two extracted subphrases are comparable. However, subphrases from different queries cannot be compared. In another example the phrase “cheap motel in lake Tahoe during thanksgiving” produces “motel lake Tahoe” having a score of 0.52 and “lake Tahoe thanksgiving” having a score of 0.50. However, comparing the different queries the scores do not indicate that (“Toyota Camry car accident report”, “car accident report”, score 0.54) is better than (“cheap motel in lake Tahoe during thanksgiving”, “motel lake Tahoe”, score 0.52). The scores are not comparable because a score generated in sequence labeling learning is the probability of the subphrase for a query, it is not a basis for measuring if a (query1, subphrase) pair is better than another (query2, subphrase). However, a global scoring schema is needed in a sponsored search. The system can measure all (query, subphrase) pairs so that the thresholding can be done to tune the coverage, CTR, and price per click (PPC) metrics.

The second component in the system is regression modeling. Since a regression model is used, the objective function can include any important factors to be estimated and the scores (values of the objective function) can be compared globally. In a sponsored search, the element is (query, subphrase) pair and the objective can be semantic similarity or clickability (measured by click over expected click/COEC) or a combination of them. This model provides flexibility that a sequence labeling technique cannot offer. The regression model can be applied on the query pair level, in other words, it only uses the query pair level features such as edit distance between queries and web features such as number of url in common for the query pairs.

However, using a regression model alone also has drawbacks. First, the regression model approach cannot generate subphrase by itself but needs to have a query pair to score, so there must be subphrase candidate generation process before scoring. Second, the regression model approach cannot identify contextual features that are very important in deriving meaningful subphrases for a query. A hybrid machine learning approach is disclosed which synergizes the sequence labeling modeling and regression modeling so that the strength from both models can be leveraged.

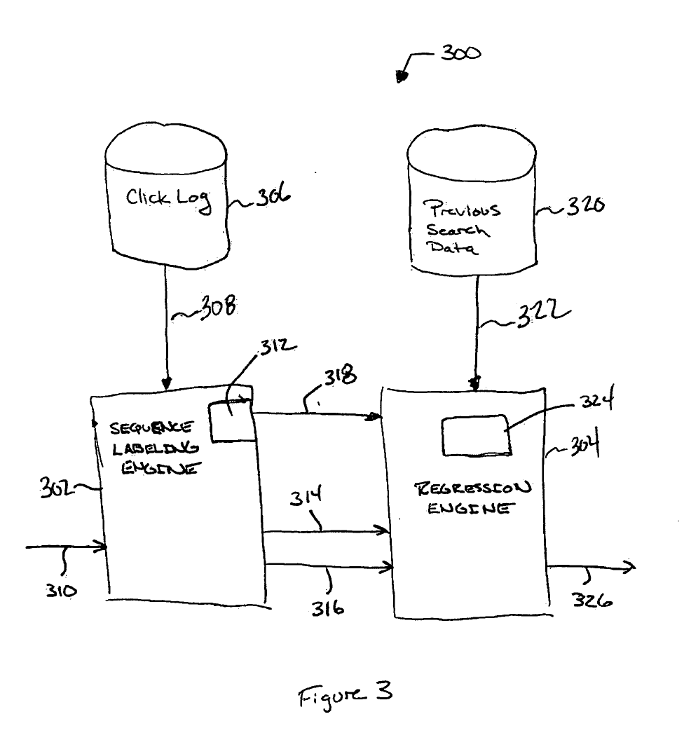

FIG. 3 illustrates the hybrid system 300 including a sequence labeling engine 302 and a regression engine 304. As discussed above, the sequence labeling engine 302 and the regression engine 304 may be performed within the advertisement engine, within the query engine, or other appropriate modules of the system 300. The sequence labeling engine 302 is in communication with a click log 306 to receive statistical information about the words or combination of words that are associated with the advertisements. For example, the click log 306 may provide the clickability or conversion rate for certain words or phrases that are bid on in association with various advertisements. The sequence labeling engine analyzes the statistical information 308 and develops ratings for various contextual features of the sequence labeling model. The ratings are developed during a training process that may take place when the system is off line.

During run time, a query string 310 is provided to the sequence labeling engine and the sequence labeling model is used to generate a list of subphrase query pairs along with a list of labels for each token of the subphrase query pair to the regression engine 304 for further processing. In addition, the contextual feature ratings 312 are also provided to the regression engine as denoted by line 318. During training, the regression engine 304 may be in communication with a repository of previous search data 320 to receive previous search query information as denoted by line 322. The regression engine 304 may use the previous search information 322 along with the contextual feature ratings 318 and generate phrase similarity feature ratings as denoted by block 324. The contextual feature ratings 318 and the phrase similarity feature ratings 324 may be used to generate a regression model that optimizes the clickability of the subphrase pairs. During run time, the regression model operates on the list of subphrase pairs 314 and the list of labels 316 provided from the sequence labeling engine to score and select the subphrase query 326.

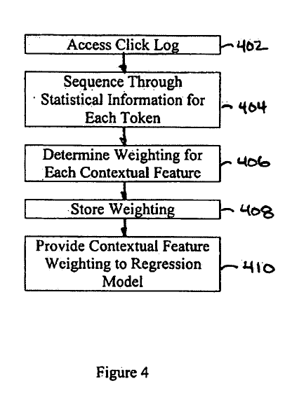

FIG. 4 shows a flow chart for the sequence label model training. The process starts in block 402 where the click log for the advertisements is accessed to retrieve statistical information for words or phrases bid on by advertisements. In block 404, the sequence labeling model is used to sequence through the statistical information and compare the statistical information for each word in the phrase. In block 406, a rating is determined for each contextual feature based on the statistical information. The ratings are then stored in block 408 and may be provided to the regression model as denoted by block 410.

To identify candidate subphrase queries, a Maximum Entropy (MaxEnt) and Conditional Random Field (CRF) method were developed to learn the important contextual features of the search string. These contextual features may include but are not limited to:

a. Current word

b. Left bi-gram

c. Right bi-gram

d. Two-side tri-gram

e. Previous label

f. Left label bi-gram

For example, the current token (word) is “car” may have a related score for importance. Similarly, a score may be assigned to the association of two or more words. Accordingly, the left bi-gram (the association of the current word and the word to the left, e.g, “race car”) may be assigned a score. Similarly, the right bi-gram (the association of the current word and the word to the right, e.g., “car dealer”) may be assigned a score. The two-side tri-gram (the association of the words to the immediate left and immediate right of the current word and the current word, e.g., “race car dealer”) may also be assigned a score. The labels assigned to other words may also be considered in determining the label for the current word. For example, the label of the previous word in the phrase may be considered. The result of the training process is a set of weightings for each contextual feature.

As such the sequence labeling model may be formulated as shown below.

Given a query q.

q=[u₁u₂ . . . u_{L}]

Tag each word or unit with tag t in {1=KEEP, 0=DROP}

t=[t₁t₂ . . . t_{L}]

sp=a sequence of uᵢ with t₁=1

### EXAMPLE

where can I buy DVD player online

0 000 1 1 0

Specifically, a maximum entropy model implementation may be defined as provided below.

Given a set of training data, {(q,t)ⱼ|j=1,2, . . . ,n}

where (q,t)=([u₁u₂ . . . u_{L}], [t₁t₂ . . . t_{L}])

Probability model

p(tᵢ|c(uᵢ))=1/Zπwⱼ^{f}^{ⱼ}^{(t}^{ᵢ}^{,c(u}^{ᵢ}⁾

where wⱼ is the weight associated with feature fⱼ(t,c), and Z is a normalization factor.

Weights can be learned from training data using generalized iterative scaling (GIS) or low-memory Broyden-Fletcher-Goldfarb-Shanno (L-BFGS) optimization algorithms.

### Prediction:

maxₜ(p(t|q))=maxₜ π p(tᵢ|c(uᵢ))

Search algorithm can use Beam search or Viterbi search.

Alternatively, the conditional random field model may be defined as provided below.

Given a set of training data {(q,t)ⱼ|j=1,2, . . . ,n} where (q,t)=([u₁u₂ . . . u_{L}], [t₁t₂ . . . t_{L}])

Probability model

$$p ( t \vert q ) = 1 / Z exp ( {\sum }_{i = 1}^{L} {\sum }_{j = 1}^{K} {w}_{j}^{{f}_{j} ( {t}_{i - 1} , {t}_{i} , i , q )} )$$

Weights can be learned from training data using an improved iterative scaling (IIS) algorithm.

### Prediction:

maxₜ(p(t|q))

Search algorithm can use Beam search or Viterbi search.

After the training, the generated model can work as a subphrase generation module. In addition, it can learn a set of most important contextual features to predict commercial subphrases. Each contextual feature has an importance weight, which can be incorporated into other classification/regression models downstream.

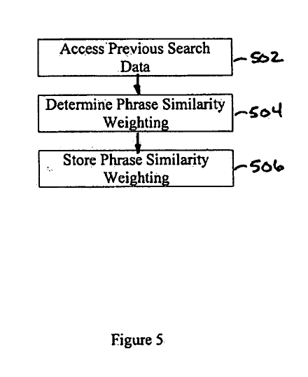

FIG. 5 illustrates a process for training the regression model. The process starts in block 502 where previous search data is provided as an input for the regression model. For example, the regression model may utilize the past three months of search strings and subphrases that bidded on by advertisers as representative data for training the model. In block 504, weightings are developed for the phrase similarity features of the regression model optimizing the model for clickability. The phrase similarity ratings are stored as denoted in block 506 for use during run time.

A gradient descent boosting tree (such as TreeNet™ from Salford Systems, San Diego, Calif.) may be used as the regression model, the gradient descent boosting tree may target combined COEC and relevance scores on query pairs. Many different query-pair level features may be used, for instance:

a. Number of tokens in common

b. Length difference

c. Number of web results for query and subphrase

d. Maximum bid over all bids from the subphrase

e. Number of bid for the subphrase

f. Etc.

After the learned important features are determined for labeling a token as KEEP and DROP, an algorithm was designed to incorporate those contextual features into the regression training and testing phase. The algorithm follows:

Based on the max-ent/crf training, two sets of the most important contextual features and their weights are identified, S1 and S2. S1={(r₁, w₂),(r₂,w₂), . . . ,(rₘ,wₘ)}. S2 takes the same form. Each set has m contextual features. S1 and S2 consist of important features for labeling a token as KEEP and DROP, respectively. For example, S1 includes the sets of features that contribute most to keeping a word and S2 includes the sets of features that contribute most to dropping a word. Accordingly, r corresponds to each feature (left bi-gram, right-bi-gram, etc) and w is the weight associated with that feature.

For each query pair (q1, q2) used in regression training and scoring, q1=[t₁,t₂, . . . ,t_{N}], where N is the length of q1
a. Based on q2 and q1, a binary vector of q1 is generated, v=[b₁,b₂, . . . ,b_{N}], bᵢ=1 if tᵢ is in q2, bᵢ=0 otherwise
b. Initialize the contexture feature rⱼ=0 for each rⱼ in S1 and S2.
c. For each tᵢ in q1
   i. For each (rⱼ,wⱼ) in S1
      1. if (rⱼ,wⱼ) is true for tᵢ and bᵢ=1 in v, then the value of the feature rⱼ is added wⱼ for this query pair in TreeNet regression training and scoring, otherwise the value of the feature rⱼ is 0 for the query pair
   ii. For each (rⱼ,wⱼ) in S2
      1. if (rⱼ,wⱼ) is true for tᵢ and bᵢ=0 in v, then the value of the feature rⱼ is added wⱼ for this query pair in TreeNet regression training and scoring, otherwise the value of the feature rⱼ is 0 for the query pair
d. Add all the features in S1 and S2 to TreeNet regression training or scoring for the query pair (q1,q2)

For example, {f₁, f₂, . . . , f₂₀₀} are available to check for a word t in the query, if it matches f₁ and f₄, weight w₁ and w₄ may be assigned for these 2 features respectively, and give 0 to other features. For another word v in the same query that matches f₁ and f₆, w1 will be added to the existing value of f₁, so now the value of f₁ is 2w₁, and w₆ will be added to f₆. So the feature for the query now will be f₁=2w₁, f₄=w₄, f₆=w₆, and all others are 0. In this way, the weight w for each feature f will still be used. So the value for each feature f is not binary (0 or w). It maybe 0, w, 2w, 3w, etc, depends on how many times a word t in the query matches this feature. Using 0, w, 2w, 3w, instead of 0, 1, 2, 3 will give the regression tree more resolution when decides the splitting point on each node. The TreeNet regression model incorporates those contextual features learned from MaxEnt/CRF in the training and scoring phases to generate subphrases for ads matching.

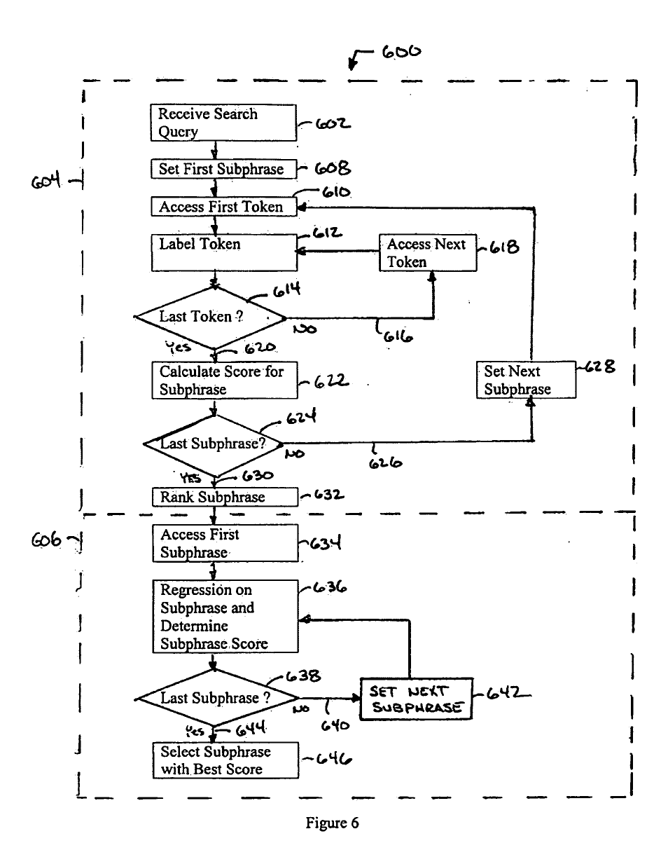

Referring now to FIG. 6, one embodiment of the run time process is illustrated and denoted by reference number 600. In block 602, a search query is received. For illustrative purposes, box 604 may denote operations of the sequence labeling engine and box 606 may denote steps performed by the regression engine 304. In block 608, the first subphrase is initialized, the first word token (i.e., word, unit) is accessed in block 610. In block 612, the label for the token is determined. The label for the token may be determined by calculating the current word score, the left bi-gram score, the right bi-gram score, the two-sided trigram score, the previous label score, and the left label bi-gram score. The label then may be based on a combination of the contextual feature scores for example by weighting and adding each score to generate a combined score.

The combined score may be carried along with a label for determining a subphrase score. In block 614, the system determines if the last token of the subphrase has been reached. If the last token of the subphrase has not been reached, the process follows line 616 to block 618. In block 618, the next token is accessed and the process continues by labeling the next token in block 612. If the last token is reached in block 614, the process follows line 620 to block 622. In block 622, a score is calculated for each subphrase. In block 624, the system determines if the number of top subphrases has been reached. If the number of top subphrase has not been reached, the process follows line 626 to block 628. In block 628, the next subphrase is examined and the process continues to block 610 where the first token is accessed for the next subphrase such that the process loops through each subphrase as described above. In this process, at any time, only top N subphrases may be retained. If the number of top subphrase has been reached in block 624, the process follows line 630 to block 632 and returns the ranked subphrase queries based on the score for each subphrase.

A list of the top subphrase query pairs in labels may then be provided to the regression model. In block 634, the first subphrase is accessed from the list of subphrase query pairs. In block 636, a regression is run on the subphrase including the contextual features and the phrase similarity features to determine a subphrase query score. In block 638, the system determines if the last subphrase has been scored. If the last subphrase has not been scored, the process follows line 640 to block 642 and the next subphrase query pair is accessed and a regression is run on the subphrase query as denoted by block 636. However, if the last subphrase is scored in block 638, the process follows line 644 to block 646. In block 646, the subphrase with the highest score is selected and the search is initiated on the subphrase query with the highest score.

The system formulates the subphrase generation as a NLP sequence labeling problem and proposed an integration approach which combines the NLP machine learning and relevance/COEC based regression modeling. The two models complement each other in the context of subphrase extraction. This hybrid approach leverages the strength of both models so that a global scoring mechanism is delivered and the important contextual features are learned and incorporated into the regression model. The testing results on two different training and testing sets demonstrated that the hybrid modeling system has clearly higher COEC/recall performance compared to the current systems yet offer the same flexibility as well:

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

We claim:

1. A system for generating subphrase queries, the system comprising:
a sequence label modeling engine to generate a plurality of subphrase queries by indexing through each token in a search phrase and labeling each token based on an association to other tokens in the search phrase;
a regression modeling engine configured to score each subphrase query at least partially on the association based on a scoring model and identify a highest score subphrase query.

2. The system according to claim 1, wherein the sequence label modeling engine utilizes a maximum entropy machine learning model.

3. The system according to claim 1, wherein the sequence label modeling engine utilizes a conditional random field machine learning model.

4. The system according to claim 1, wherein the sequence label modeling engine labels each token based on a current token score.

5. The system according to claim 1, wherein the sequence label modeling engine labels each token based on a left bi-gram score.

6. The system according to claim 1, wherein the sequence label modeling engine labels each token based on a right bi-gram score.

7. The system according to claim 1, wherein the sequence label modeling engine labels each token based on a two-side tri-gram score.

8. The system according to claim 1, wherein the sequence label modeling engine labels each token based on a previous label score.

9. The system according to claim 1, wherein the sequence label modeling engine labels each token based on a left label bi-gram score.

10. The system according to claim 1, wherein the regression model engine scores each subphrase query based on a number of tokens in common with the search phrase.

11. The system according to claim 1, wherein the regression model engine scores each subphrase query based on a length difference between the subphrase query and the search phrase.

12. The system according to claim 1, wherein the regression model engine scores each subphrase query based on a number of search results in common with search results for a search query.

13. The system according to claim 1, wherein the regression model engine scores each subphrase query based on a maximum bid over all bids for the subphrase query.

14. The system according to claim 1, wherein the regression model engine scores each subphrase query based on a number of bids for the subphrase query.

15. A method for generating a subphrase query, the method comprising:
indexing through each token in a search phrase;
labeling each token based on an association to other tokens in the search phrase;
generating a plurality of subphrases based on the labeling;
scoring each subphrase query based on a regression model; and
identifying a highest score subphrase query.

16. The method according to claim 15, wherein each subphrase is scored based on a maximum entropy model.

17. The method according to claim 15, wherein each subphrase is scored based on a conditional random field model.

18. The method according to claim 15, wherein each subphrase is scored based on a current token score.

19. The method according to claim 15, wherein each subphrase is scored based on a left bi-gram score.

20. The method according to claim 15, wherein each subphrase is scored based on a right bi-gram score.

21. The method according to claim 15, wherein each subphrase is scored based on a two-side tri-gram score.

22. The method according to claim 15, wherein each subphrase is scored based on a previous label score.

23. The method according to claim 15, wherein each subphrase is scored based on a left label bi-gram score.

24. A system for generating a subphrase query, the system comprising:
means for indexing through each token in a search phrase;
means for labeling each token based on an association to other tokens in the search phrase;
means for generating a plurality of subphrases based on the labeling;
means for scoring each subphrase query based on a regression model; and
means for identifying a highest score subphrase query.
